(19) United States
(12) Patent Application Publication
(10) Pub. No.: US 2008/0171155 A1
(43) Pub. Date: Jul. 17, 2008

(54) Signage Visible Only When Wet

(76) Inventors: Richard Wayne Haupt, Trophy Club, TX (US); Brant Edward Malkey, Euless, TX (US); Alisha Diane Roach, Carrollton, TX (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 11/622,145

(22) Filed: Jan. 11, 2007

(51) Int. Cl. E01C 11/24; B44D 5/00; B41M 5/00

(52) U.S. Cl. 428/29; 427/145; 427/136

(57) ABSTRACT

Signage for use on a substrate having a porous surface, the signage being substantially visually indistinguishable from the substrate to an ordinary observer when the substrate is dry but readily visible when the substrate is wet. The signage is made by applying to selected portions of the porous surface a hydrophobic material, preferably silica-based compounds such as potassium methyl siliconate and polymethylsilicic acid.

### BACKGROUND OF THE INVENTION

1. Field of the Invention

This invention relates to signage (including signs, images and other indicia) applied to a porous substrate, such as concrete and other materials having porous surfaces, which signage is not plainly visible to an ordinary observer when the substrate is dry, but is visible when the substrate is wet. This invention eliminates the need for placement and removal of temporary or other signage indicating, for example, that a substrate surface is slippery when wet.

2. Description of Related Art

Words, symbols and other indicia are used in a wide variety of ways and on a wide variety of surfaces to convey some message or meaning to observers. Warnings are often needed, for example, when walkways or roadways become slippery due to moisture that accumulates from rain, dew, sprinkler systems, spills or other sources. The use of a warning is typically necessary only when the particular reason to take care exists, such as when a surface is slippery due to the presence of moisture. Warning pedestrians or motorists that a surface is hazardous when wet reduces accidents, injuries and property damage, thereby promoting public safety.

Conventional temporary warning signage must be deployed when a hazard exists, and then removed when no longer needed, thereby contributing to associated cost and expense. Additionally, the use of portable signage is more subject to theft, damage or loss. Conventional permanent warning signage is more expensive to install and maintain, can detract from the aesthetics of the locale in which it is installed, and is more likely to be ignored because it is always part of the surroundings. Signs painted upon concrete and other substrates with conventional paints often produce a coated surface that is more slippery that the substrate itself, especially when wet. As a result, the sign itself may contribute to the dangerous condition for which it is intended to provide a warning.

It has previously been known in the prior art to seal or coat certain porous substrates such as concrete that have a relatively rough appearance. These coating materials can be used to provide a smoother appearance and enhanced luster to the porous substrate. Some such compounds include various epoxies, fluoropolymers, rubber-based compounds, polymers, and siloconates. Because these compounds are intended to protect and improve quality of the porous surface, they are typically spread across the entire porous surface, such as a concrete floor or walkway.

### SUMMARY OF THE INVENTION

The subject invention relates to signage, including text, graphical images, symbols or other indicia, that is installed on a substrate having a porous surface, and is readily visible to an ordinary observer only when the surface is wetted with water. Such signage can be installed, for example, on a post, wall, walkway, roadway, or overhead or overhanging surface, provided that such surface is porous and that the portion of the substrate not comprising the signage has a visual appearance that is noticeably different when wet than when dry.

According to one embodiment of the invention, signage is disclosed that comprises a hydrophobic coating applied to a selected portion of an otherwise porous substrate in such manner that the coated portion corresponds to images, symbols, words, or other indicia. Subsequent wetting of the overall surface changes the hue, tone, or color of the untreated areas of the porous substrate but not the areas coated with the hydrophobic coating, thereby rendering the coated portion visible to an ordinary observer. In one preferred embodiment of the invention, the porous substrate is unsealed concrete and the preferred hydrophobic material is an aqueous solution of potassium methyl siliconate.

According to another embodiment of the invention, a method is provided for creating a sign or other image on a porous substrate, which sign or image is only visible to an ordinary observer when the substrate is wet. The method includes selecting a dry substrate that changes hue, tone, or color when wetted with water; applying a hydrophobic material to a selected portion of the dry substrate that conforms to the words, boundaries or other indicia of the desired sign image; and allowing the hydrophobic material to dry. A preferred substrate for use in the method of the invention is unsealed concrete and a preferred hydrophobic material is an aqueous solution of potassium methyl siliconate.

### BRIEF DESCRIPTION OF THE DRAWINGS

A preferred embodiment of the invention is further described and explained in relation to the following drawing figures wherein:

FIG. 1 is a top plan view showing in illustrative form signage of the invention as installed on a sidewalk section made of dry concrete, wherein the broken lines are intended to indicate that the sign is not visible to a casual observer; and

FIG. 2 is a top plan view of the sidewalk section of claim 1 wherein the warning sign has become visible to a casual observer due to wetting of the concrete surrounding the sign with water.

### DESCRIPTION OF THE PREFERRED EMBODIMENTS

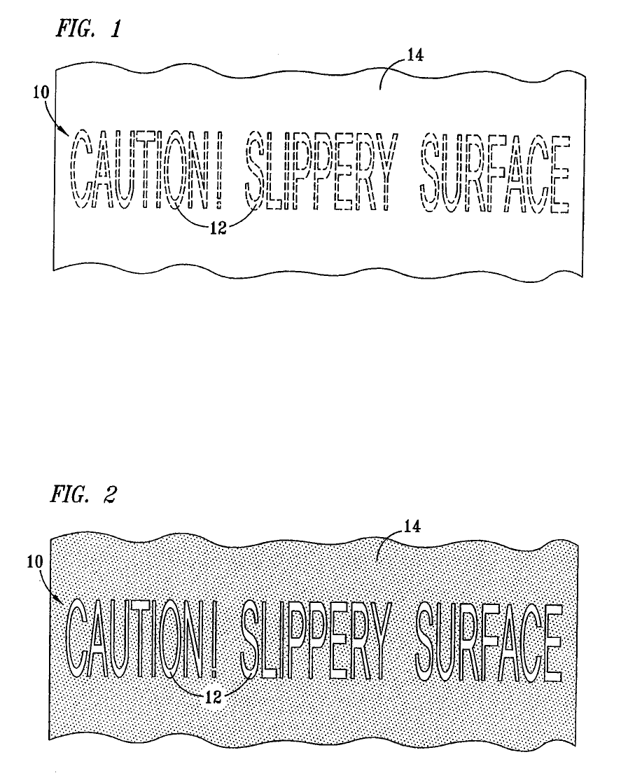

FIG. 1 depicts a section of unsealed concrete sidewalk 12 comprising signage 10 of the current invention. According to this preferred embodiment, signage 10 is made by applying hydrophobic material 12 to the upwardly facing surface of concrete sidewalk section 14 in the shape of the letters and symbols needed to create the warning message: “CAUTION! SLIPPERY SURFACE.” Hydrophobic material 12 is desirably clear, or at least sufficiently translucent or neutral in color in relation to sidewalk section 14, that signage 10 is substantially invisible (i.e., not readily visible or noticeable to a casual observer) when concrete sidewalk section 14 is dry. For this reason, signage 10 is depicted in phantom outline in FIG. 1. It should be understood, however, that close inspection may enable a careful observer to determine which portions of concrete sidewalk section 14 are coated, and possibly thereby decipher signage 10, even when dry. In such case, signage 10 will still fall within the scope of the invention as it is not readily visible or noticeable to a casual observer from a distance that signage 10 would normally be viewed until such time as the surface is wetted.

FIG. 2 depicts the same concrete sidewalk section 14 as shown in FIG. 1 after it has been wetted with water. The concrete surface portions of sidewalk section 14 that are not coated with the hydrophobic material 12 used to create signage 10 have darkened as a result of absorbing water into the porous concrete surface, thereby producing a visible contrast with the coated portion and rendering signage 10 readily visible to an ordinary observer. In contrast, the portion of concrete disposed under the coating of hydrophobic material 12 has substantially retained its original color, hue, and tone. Once the uncoated concrete in sidewalk section 14 dries out, it will return to its original color, hue, and tone, thereby again rendering signage 10 substantially invisible again as shown in FIG. 1.

The signage of the invention is particularly useful for warning people of any temporary or intermittent danger that is present when the affected porous surface is wetted with water or with another aqueous solution that will not otherwise discolor the underlying porous substrate or be opaque to the signage. In that case, the warning signage is visible only when the particular hazard is present, because it is only visible when the surface is actually slippery due to wetness. Instead of a text message as depicted in FIGS. 1 and 2, the signage may contain another visible depiction such as accepted warning symbols or other indicia to convey the desired message. Alternatively, the hydrophobic material can be applied to the porous substrate in the form of an image, words, or indicia to convey a commercial or informational message, or a purely artistic effect. Preferably, the commercial or informational message is one that is applicable or appropriate to the conditions that cause the signage to appear.

Although signage 10 is preferably applied to a surface that is affected by hazardous condition, such as a walkway that is slippery when it is wet, signage 10 can also be applied to a porous substrate that is near the surface that is susceptible to the hazardous condition. For example, signage 10 can be applied to a wall or overhang that is itself made of a porous substrate and is also near to and visible from a walkway or staircase that is slippery when wet. This may be particularly desirable for use in circumstances where a walking surface or stairs are made of metal or another material that is slippery when wet but is not porous or susceptible to being coated with a hydrophobic material that will dry in such manner as to become substantially invisible.

The porous substrate to which the signage is applicable can include any material, most preferably a substantially rigid material, that can be coated with hydrophobic material 12 to produce a text message or other visual image that will be substantially invisible when dry, and that will undergo a visible change in hue, tone or color when wetted with water or another aqueous liquid so as to produce a visual contrast with the hydrophobic material. A particularly preferred substrate is unsealed concrete. Unsealed concrete has a porous surface to which the preferred hydrophobic material can readily adhere. The porous surface of the concrete that is uncoated by the hydrophobic material also readily absorbs-water, producing an associated darkening in color, hue, and tone that is visually apparent to an ordinary observer. Once the concrete dries out, the original color, hue, and tone return. The concrete will again darken in appearance upon subsequent contact with water. Other porous substrates suitable for use in some applications of the invention include, for example, low-fired clay products, gypsum and gypsum-based plasterboards, and aerated concrete.

The hydrophobic material of the current invention can be any material that (1) can be applied to the substrate to prevent water or another aqueous liquid from changing the color, hue, and/or tone of the substrate; and (2) will itself be substantially invisible to the ordinary observer when applied to a portion of the substrate to create a desired signage and allowed to dry. The term “hydrophobic material” should be further understood to include both compositions that form a hydrophobic coating when applied to the surface of a porous substrate and compositions that are hydrophobic prior to their application to a porous substrate.

A preferred hydrophobic material for use in the invention is an aqueous solution of potassium methyl siliconate. Potassium methyl siliconate can be applied to the surface of the substrate or it can be mixed with a portion of the uncured substrate. Potassium methyl siliconate reacts with atmospheric carbon dioxide to form a clear layer of polymethylsilicic acid on the coated concrete surface. The polymethylsilicic acid is hydrophobic and prevents moisture from reaching the porous substrate surface that remains visible underneath it.

In a preferred embodiment, when a concrete substrate is wetted, for example, as a result of precipitation, operation of a lawn sprinkler system, water spray blowing from a fountain, or the like, some of the water will penetrate into the porous surface of the uncoated portions of the concrete substrate. This will cause the uncoated concrete to darken visibly in color, hue, and/or tone. However, the coating layer of polymethylsilicic acid used to produce signage 10 of the invention prevents water from penetrating into the concrete in the coated portion of the substrate. As a result, the untreated areas of concrete darken while the treated areas remain the original color, hue, and tone, thereby rendering visible the pattern of treated areas forming the desired text, images, or other indicia. When the concrete dries out, the untreated areas desirably return substantially to their original color, hue, and/or tone, and the desired words, images, or other indicia are no longer distinctly visible.

One of the reasons that polymethylsilicic acid is preferred for use as the hydrophobic element is that, when applied to concrete, which is often used for walkways or roadways, it does not make the concrete more slippery when wet. One way to measure the slipperiness of a surface is to measure the static coefficient of friction of the surface. This can be accomplished using The American Society for Testing and Materials (ASTM) Standard C1028, which is a Horizontal Dynamometer Pull-Meter Method used to measure the static coefficient of friction of a surface.

Similar alumina-based materials, alkoxysilane emulsions, epoxy or polyurethane systems can also be used as the hydrophobic materials. However, these other materials may make the concrete more slippery when wet. As such, they are currently less preferred than polymethylsilicic acid.

### EXAMPLE 1

The preferred hydrophobic material, polymethylsilicic acid, is applied to a concrete surface to form a warning sign. The concrete surface has a light broom finish on it. Using the ASTM standard C1028, the coefficient of friction for the bare untreated concrete surface is 1.00 when dry. In comparison, the concrete that is coated with the polymethylsilicic acid has a coefficient of friction of 0.97. While this represents a slight decrease compared to the untreated concrete, the coefficient of friction is still high enough that the minor drop is not significant.

When the light broom-finished concrete is wet, the untreated concrete area has a coefficient of friction of 0.74. The coefficient of friction on the portion of concrete coated with polymethylsilicic acid is 0.77. This represents a slight improvement in traction over the untreated concrete. As a result, the use of polymethylsilicic acid to form a warning sign on concrete does not contribute to the slippery conditions about which the sign is intended to warn people. However, because the coefficient of friction is still significantly lower than that of the dry concrete, it is still desirable to warn people of the slippery conditions when the concrete is wet.

### EXAMPLE 2

A second example shows the effect of a polymethylsilicic acid coating on a concrete surface that has a smooth, hard-trowel finish. Again using the ASTM standard identified above, the coefficient of friction for the bare concrete surface bare is 0.58 when dry and 0.49 when wet. In contrast, the portion of the concrete that is coated with the polymethylsilicic acid has a coefficient of friction of 0.64 when dry and 0.69 when wet. With the smooth-surface concrete, the use of polymethylsilicic acid increases the coefficient of friction under both wet and dry conditions. When the concrete is wet, the area coated with polymethylsilicic acid is up to 38% less slippery than the untreated concrete surface.

A preferred method of creating various embodiments of the current invention is as follows. A porous substrate is selected for locating the desired sign, message, image, or other indicia. A particularly preferred substrate is unsealed concrete. A clear hydrophobic material is then applied to the porous substrate. This can be accomplished by spraying, brushing or otherwise coating the hydrophobic material onto the substrate so that, when dry, the hydrophobic element prevents moisture from penetrating into the substrate in the area(s) necessary to form the desired signage. If the hydrophobic material is sprayed onto the porous substrate, a stencil mask is preferably used to prevent the hydrophobic material from coating portions of the substrate outside the boundaries of the signage.

Sufficient hydrophobic material should be applied to the substrate such that the entire portion that forms the desired signage is entirely covered. A preferred hydrophobic material, an aqueous solution of potassium methyl siliconate, is desirably applied to the concrete, with sufficient solution being applied that the portion of concrete forming the signage is completely wetted with the solution.

In an alternate embodiment of the invention, the hydrophobic material is mixed with a portion of the substrate before the surface is formed. If desired, a depression can be formed in the substrate surface in the shape of the words, images, or indicia of the desired sign. This can be accomplished by stamping the substrate surface as it is being formed or by cutting or grinding out a portion of the substrate surface after it is formed. The depression is then filled in with an unhardened portion of the substrate material that has been mixed previously with the hydrophobic material.

### EXAMPLE 3

A stamp is used to imprint desired signage into a concrete walkway after the concrete surface is prepared but not yet hardened. A hydrophobic material, such as an aqueous solution of potassium methyl siliconate, is then mixed with an amount of unset concrete. This concrete, with the hydrophobic material in it, is then used to fill in the depressions left by the stamp, and is leveled with the remaining concrete walkway to form an even and flat surface. As the concrete sets, the potassium methyl siliconate reacts with carbon dioxide in the air to form polymethylsilicic acid. After the concrete cures, water contacting the areas of concrete not mixed with the hydrophobic material visibly darken in contrast to the treated areas. The areas of concrete mixed with the hydrophobic material do not absorb a significant amount of water and do not noticeably darken or otherwise change hue, color, or tone, and the signage is visible due to the visual contrast between the untreated and untreated portions of concrete.

The above descriptions of certain embodiments are made for the purposes of illustration only and are not intended to be limiting in any manner. Other alterations and modifications of the preferred embodiment will become apparent to those of ordinary skill in the art upon reading this disclosure, and it is intended that the scope of the invention disclosed herein be limited only by the broadest interpretation of the appended claims to which the inventor is legally entitled.

What is claimed is:

1. Signage comprising:
a substrate having a porous surface that, when viewed by an ordinary observer, has a first visual appearance when dry, and a second visual appearance when wetted with a substantially clear aqueous liquid; and
a hydrophobic material applied to selected portions of the porous surface, which selected portions collectively define a desired textual or graphic image, wherein the hydrophobic material causes the selected portions to maintain the first visual appearance when the substrate is contacted by the substantially clear aqueous liquid.

2. The signage of claim 1 wherein the substrate is substantially rigid.

3. The signage of claim 2 wherein the substrate is selected from the group consisting of unsealed concrete, aerated concrete, low-fired clay, gypsum, and gypsum based plasterboard.

4. The signage of claim 2 wherein the substrate comprises concrete.

5. The signage of claim 1 wherein the selected portions of the porous surface are coated with the hydrophobic material.

6. The signage of claim 1 wherein the selected portions of the porous surface comprise the hydrophobic material.

7. The signage of claim 1 wherein the hydrophobic material comprises a silica-based material.

8. The signage of claim 7 wherein the hydrophobic material comprises polymethylsilicic acid.

9. The signage of claim 7 wherein the hydrophobic material comprises an aqueous solution of potassium methyl siliconate.

10. The signage of claim 1 wherein the substantially clear aqueous liquid is water.

11. The signage of claim 1 wherein the hydrophobic material does not substantially change the first visual appearance of the selected portions of the porous surface to which it is applied.

12. The signage of claim 1 wherein the substrate is a walkway.

13. The signage of claim 1 wherein the substrate is a roadway.

14. The signage of claim 1 wherein the substrate is a wall.

15. The signage of claim 1 wherein the selected portions of the porous surface that collectively define the desired textual or graphic image comprise at least one depression, and wherein the at least one depression is filled with a mixture of an unhardened portion of the substrate and the hydrophobic material.

16. The signage of claim 1 wherein the porous surface has a coefficient of friction and wherein the applied hydrophobic material does not significantly decrease the coefficient of friction.

17. The signage of claim 16 wherein the applied hydrophobic material increases the coefficient of friction of the porous surface when the porous surface is wetted.

18. A method for creating signage on a substrate, which signage is visually indistinguishable from the substrate to an ordinary observer when the substrate is dry and is readily visible to the ordinary observer when the substrate is wetted with a substantially clear aqueous liquid, by:
providing a substrate having a porous surface visible to the ordinary observer, the substrate having a first visual appearance when dry, and a second visual appearance when wetted with a substantially clear aqueous liquid;
applying hydrophobic material to selected portions of the porous surface, which selected portions collectively define a desired textual or graphic image for the signage, wherein the hydrophobic material causes the selected portions to maintain the first visual appearance when the substrate is contacted by the substantially clear aqueous liquid; and
allowing the hydrophobic material to dry prior to wetting with the substantially clear aqueous liquid.

19. The method of claim 18 wherein the substrate is substantially rigid.

20. The method of claim 19 wherein the substrate is selected from the group consisting of unsealed concrete, aerated concrete, low-fired clay, gypsum, and gypsum based plasterboard.

21. The method of claim 19 wherein the substrate comprises concrete.

22. The method of claim 18 wherein the selected portions of the porous surface are coated with the hydrophobic material.

23. The method of claim 18 wherein the selected portions of the porous surface comprise the hydrophobic material.

24. The method of claim 18 wherein the hydrophobic material comprises a silica-based material.

25. The method of claim 24 wherein the hydrophobic material comprises polymethylsilicic acid.

26. The method of claim 24 wherein the hydrophobic material comprises an aqueous solution of potassium methyl siliconate.

27. The method of claim 18 wherein the substantially clear aqueous liquid is water.

28. The method of claim 18 wherein the hydrophobic material does not substantially change the first visual appearance of the selected portions of the porous surface to which it is applied.

29. The method of claim 18 wherein the substrate is a walkway.

30. The method of claim 18 wherein the substrate is a roadway.

31. The method of claim 18 wherein the substrate is a wall.

32. The method of claim 18 wherein the selected portions of the porous surface that collectively define the desired textual or graphic image comprise at least one depression, and wherein the at least one depression is filled with a mixture of an unhardened portion of the substrate and the hydrophobic material.

33. The method of claim 18 wherein the porous surface has a coefficient of friction and wherein applying the hydrophobic material to the selected portions of the porous surface does not significantly decrease the coefficient of friction of the selected portions.

34. The method of claim 33 wherein applying the hydrophobic material to the selected portions of the porous surface increases the coefficient of friction of the porous surface when the porous surface is wetted.

35. The method of claim 18 where the hydrophobic material is applied to the selected portions of the porous surface with a paint brush, spreader, roller or sprayer.

36. The method of claim 18 wherein the hydrophobic material is applied to the porous substrate by:
covering a portion of the substrate with a stencil, wherein the stencil exposes only the selected portions of the porous surface that collectively define the desired textual or graphic image;
spraying the hydrophobic material onto the exposed selected portions of the porous surface; and
removing the stencil from the porous substrate.

37. The method of claim 18 wherein the hydrophobic material is applied to the porous substrate by:
forming a depression in the porous surface of the substrate in the shape of the desired indicia;
mixing the hydrophobic material with a portion of uncured substrate material;
filling in the depression with the mixture of hydrophobic material and uncured substrate material; and
allowing the mixture to cure.
